(19) United States
(12) Patent Application Publication
(10) Pub. No.: US 2024/0209149 A1
(43) Pub. Date: Jun. 27, 2024

(54) BIO-BASED POLYAMIDE ELASTOMER AND PREPARATION METHOD THEREFOR

(71) Applicants: CATHAY BIOTECH INC., Shanghai (CN); CIBT AMERICA INC., Newark, DE (US); CATHY (JINXIANG) BIOMATERIAL CO., LTD., Jining (CN)

(72) Inventors: Xiaohui ZHOU, Shanghai (CN); Xiucai LIU, Shanghai (CN)

(73) Assignees: CATHAY BIOTECH INC., Shanghai (CN); CIBT AMERICA INC., Newark, DE (US); CATHY (JINXIANG) BIOMATERIAL CO., LTD., Jining, Shandong (CN)

(21) Appl. No.: 18/583,132

(22) Filed: Feb. 21, 2024

Related U.S. Application Data
(63) Continuation of application No. PCT/CN2022/115128, filed on Aug. 26, 2022.

(30) Foreign Application Priority Data
Aug. 27, 2021 (CN) 202110992871.6

(51) Int. Cl. C08G 69/40

(52) U.S. Cl. CPC C08G 69/40

(57) ABSTRACT

A bio-based polyamide elastomer and a preparation method therefor. The bio-based polyamide elastomer is prepared using specific aliphatic diacid and pentanediamine prepared by biological methods as monomers. The polyamide elastomer of the present disclosure has excellent performance and stable monomer supply, solves the problem of excessively high cost of polyamide elastomer, expands the application scenarios of elastomers, and has high commercial value.

### CROSS-REFERENCE TO RELATED APPLICATIONS

This application is a continuation of PCT Application No. PCT/CN2022/115128, filed on Aug. 26, 2022, which claims the priority of Chinese Patent Application No. CN202110992871.6, filed on Aug. 27, 2021, the entire contents of which are incorporated herein by reference.

### TECHNICAL FIELD

The present disclosure relates to a bio-based polyamide elastomer and a preparation method therefor.

### BACKGROUND

Thermoplastic elastomers are marketed in the form of various resin compositions such as polyurethanes, polystyrenes, polyolefins, polyesters, and polyamides, etc. Thermoplastic polyamide elastomer (TPAE) is a member of the family of thermoplastic elastomers, and its development and application started relatively late compared with the widely used thermoplastic polyurethane elastomers (TPUs), thermoplastic polyolefin elastomers (TPOs), styrene thermoplastic elastomers (SBCs), thermoplastic polyvinyl chloride elastomers (TPVCs), and thermoplastic polyether ester elastomers (TPEEs), and the like. Polyamide elastomers are widely used in the fields such as automobiles, sports equipment, medical instruments, seals, mechanical parts, etc., due to their good properties, such as high elasticity, low specific gravity, high resilience, and good low-temperature performance, etc.

Thermoplastic polyamide elastomers (TPAEs) are copolymers mainly composed of polyamide hard segments and polyether or polyester soft segments, wherein as the hard segment, the polyamide mainly includes PA6, PA66, PA11, and PA12, etc., and mainly determines the properties of thermoplastic polyamide elastomers including density, hardness, melting point, tensile strength, resistance to various organic chemicals, etc.; and the soft segment mainly includes polycaprolactones (PCLs), polyethylene glycols (PEGs), poly(propylene glycol) (PPGs), and polytetramethylene ether glycols (PTMEGs), etc., and determines properties of thermoplastic polyamide elastomers including low-temperature performance, hygroscopicity, antistatic properties, dyeing properties, and stability to certain chemicals, etc.

The production of polyamide elastomers has received a great deal of attention in recent years, and many companies and research institutes have filed patents application involving various synthesis techniques by using PA6, PA11, and PA12 as hard segments. At present, the most commonly commercialized polyamide elastomers are the PA12 series, such as the XPA series products from Ube Industries, Ltd., Japan, the PEBAX series products from Arkema, France, and the VESTAMID E series products from Germany Evonik Industrial Co., Ltd. The PA12 hard segment is generally produced using dodecylamino dodecanoic acid or laurolactam which is derived from petrochemical processes, is more expensive and is monopolized by a few companies. The difficulty in obtaining monomers stably brings challenges for the large-scale production of elastomers. The carbon chain of the monomer caprolactam that constitutes PA6 based elastomers is shorter, and the over performance of elastomers with the same hardness is not as good as that of long-chain nylon-based elastomers.

It has long been hoped that bio-based raw materials could be used to produce green elastomers with comparable performance to existing grades, thus solving the problem of fossil energy consumption and building a low-carbon society.

### SUMMARY

The present disclosure provides a polyamide elastomer prepared using pentanediamine and long-chain (C10 to C18) aliphatic diacid which are prepared by biological methods, and a specific proportion of polyether, polyol, polyetheramine as raw materials, as well as a preparation method and use thereof. The elastomer has excellent performance, a lower melting point range and stable polymerization monomer supply, solves the problem of the excessively high cost of polyamide elastomer, expands the application scenarios of elastomers, and has very high commercial value.

The present disclosure provides a bio-based polyamide elastomer comprising:

a hard segment and a soft segment;

wherein the hard segment comprises a structural unit represented by formula A and a structural unit represented by formula B, which are connected by an amide bond;

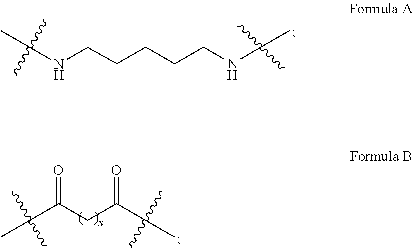

wherein, x is an integer ranging from 4 to 16;

the soft segment is derived from one or more selected from the group consisting of a polyether, a polyol and/or a polyether amine.

In some embodiments, the structural unit represented by formula A is derived from pentanediamine.

In some embodiments, the structural unit represented by formula B is derived from a dicarboxylic acid. The dicarboxylic acid is at least one selected from the group consisting of 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

In some embodiments, the molar ratio of pentanediamine to the dicarboxylic acid is in a range from 1:1.0 to 1:2.0.

In some embodiments, the molar ratio of the hard segment to the soft segment is in a range from 0.7:1 to 2:1, 0.8:1 to 1.5:1, 0.7:1 to 1.3:1, or 0.8:1 to 1.2:1.

In some embodiments, the bio-based polyamide elastomer has a relative viscosity of 1.0 to 2.0, preferably 1.1 to 1.7, and more preferably 1.3 to 1.7, which is measured by using a mobile phase of 96% concentrated sulfuric acid.

In some embodiments, the bio-based polyamide elastomer has a relative viscosity of 2.2 to 3.5, preferably 2.3 to 3.2, which is measured by using a mobile phase of 98% formic acid.

In some embodiments, the bio-based polyamide elastomer comprising a structural unit represented by formula C and a structural unit represented by formula D, which are connected by an ester group; wherein the structural unit represented by formula C comprises a structural unit represented by formula A and a structural unit represented by formula B, which are connected by an amide bond;

### Formula A

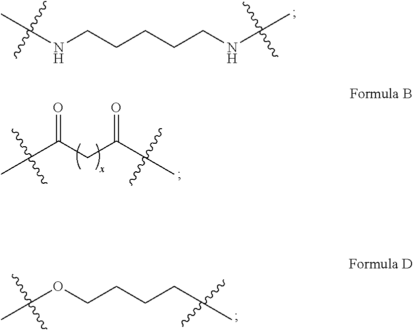

wherein, the structural unit represented by formula D is derived from polytetramethylene ether glycol (PTMEG).

In some embodiments, the bio-based polyamide elastomer is a block copolymer.

In some embodiments, the hard segment has a number-average molecular weight of 500 to 12,000, for example 500, 850, 1,400, 1,406, 2,140, 2,935, 3,000, 4,948, 2,554, 3,763, 852, 1,494, 4,973, 3,162, 4,778, 7000.

In a specific embodiment of the present disclosure, the bio-based polyamide elastomer has a number-average molecular weight of 10,000 to 70,000, preferably 10,000 to 40,000, more preferably 20,000 to 40,000, for example 39,596, 34,507, 35,880, 39,022, 38,158, 31,860, 22,739, 19,659 or 18,749, 33,711, 18,159.

In a specific embodiment of the present disclosure, the soft segment has a number-average molecular weight of 200 to 5,000, 200 to 2,000, for example 1,000, 1,500, 2,000, 2,500, 3,000, 3,500, 4,000, and 4,500.

In some embodiments, the hard segment comprises a structural unit represented by formula A, a structural unit represented by formula B and a structural unit represented by formula E, wherein the structural units represented by formulas A, B, and E are connected by amide bonds;

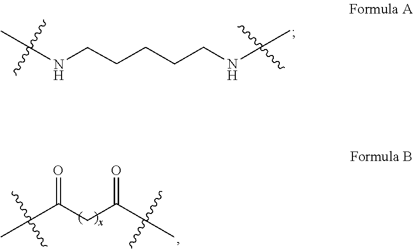

preferably, the formula B is formula B′

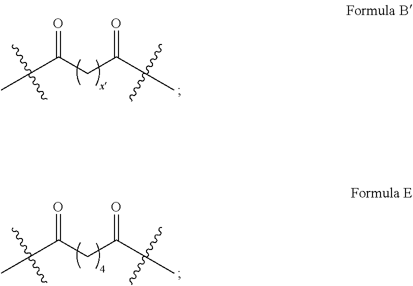

wherein, x′ is an integer ranging from 8 to 16.

In some embodiments, the bio-based polyamide elastomer contains the structural unit represented by formula A in a molar content of 5 mol % to 40 mol %, the structural unit represented by formula B in a molar content of 15 mol % to 40 mol %, and the structural unit represented by formula D in a molar content of 35 mol % to 65 mol %, and the sum of the structural units represented by formulas A, B, and D is 100 mol %.

In some embodiments, the molar ratio of the structural unit represented by formula A. formula B and formula D is 3-30:6-35:40-85.

In some embodiments, the bio-based polyamide elastomer contains the structural unit represented by formula A in a molar content of 10 mol % to 40 mol %, the structural unit represented by formula B in a molar content of 15 mol % to 40 mol %, and the structural unit represented by formula D in a molar content of 35 mol % to 65 mol %, and the sum of the structural units represented by formulas A, B, and D is 100 mol %.

In some embodiments, the bio-based polyamide elastomer contains the structural unit represented by formula A in a molar content of 15 mol % to 30 mol %, the structural unit represented by formula B in a molar content of 20 mol % to 35 mol %, and the structural unit represented by formula D in a molar content of 40 mol % to 65 mol %, and the sum of the structural units represented by formulas A, B, and D is 100 mol %.

In some specific embodiments, the molar ratio of the structural units represented by formulas A, B, E and D is 18-25:18-30:1-10:40-65.

Preferably, the molar ratio of the structural unit represented by formula A to the structural unit represented by formula B is in a range from 1:1.0 to 1:2.0.

Preferably, the structural unit represented by formula C and the structural unit represented by formula D are contained in the bio-based polyamide elastomer in a mass content of 95 wt. % or more, more preferably 97 wt. % or more.

In some embodiments, the raw materials of the bio-based polyamide elastomer comprise pentanediamine, a dicarboxylic acid and a soft segment material, and the soft segment material is one or more selected from the group consisting of a polyether, a polyol and/or a polyether amine.

In some embodiments, the raw materials of the hard segment comprises pentanediamine, a short chain dicarboxylic acid and a long chain dicarboxylic acid, wherein the short chain dicarboxylic acid is one or more selected from the group consisting of 1,6-adipic acid, 1,7-heptanedioic acid and 1,8-octanedioic acid, and the long chain dicarboxylic acid is one or more selected from the group consisting of 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

In some embodiments, the polyether is one or more selected from a polyether diol and/or a polyether polyol. The polyether diol is one or more selected from the group consisting of polyethylene glycol (PEG), polypropylene glycol (PPG), polybutylene glycol (PTMG) and polytetramethylene ether glycol (PTMEG). The polyether polyol is one or more selected from the group consisting of polypropyltriol, polybutyltetrol and polytetrahydrofuran ether triol.

In some embodiments, the polytetramethylene ether glycol has a number-average molecular weight of 500 to 5,000, or 500 to 2,000, for example PTMEG 1000 having a molecular weight of 1,000, and PTMEG 2000 having a molecular weight of 2,000.

In some embodiments, the polyether is one or more selected from PTMEG 1000, PTMEG 2000, PEG 400 or PPG1000.

In some embodiments, the polyol is one or more selected from the group consisting of pentaerythritol, ethylene glycol (EG), 1,2-propanediol (PG), glycerol, 1,4-butanediol (BDO), 1,6-hexanediol (HD), neopentyl glycol (NPG), diethylene glycol, dipropylene glycol, trimethylolpropane (TMP).

In some embodiments, the polyether amine is one or more selected from the group consisting of polyoxyethylene amine, polyoxypropylene amine and polyoxybutylene amine.

In some embodiments, the polyether amine is one or more selected from the group consisting of polyethylene glycol ether amine, polypropylene glycol ether amine, and polybutylene glycol ether amine.

In some embodiments, the polyether amine is selected from HUNTSMAN ELASTAMINE® (Series) or Jeffamine® (Series) Amine capped polyalkoxylene glycol, with number-average molecular weights ranging from 600 to 5000 g/mol.

In some embodiments, the polyether amine is one or more selected from the group consisting of poly(ethylene glycol) diamine (PEG-diamine), poly(propylene glycol) diamine (PPG-diamine), and poly(butylene glycol) amine (PBG-diamine).

In some embodiments, the polyether amine has a number-average molecular weight of 200 to 5,000, or 400 to 2000.

In some embodiments, the raw materials of the bio-based polyamide elastomer comprise pentanediamine, dicarboxylic acid(s), a PTMEG and polyol(s).

In a specific embodiment of the present disclosure, the raw materials of the bio-based polyamide elastomer comprise pentanediamine, a dicarboxylic acid and polytetramethylene ether glycol, wherein the dicarboxylic acid is any one or more selected from 1,6-adipic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

In some embodiments, the raw materials of the bio-based polyamide elastomer comprise pentanediamine, two or more different long chain dicarboxylic acids, a polytetramethylene ether glycol and polyol(s).

In a specific embodiment of the present disclosure, the bio-based polyamide elastomer is prepared by a method comprising: polymerizing pentanediamine and a dicarboxylic acid to obtain a prepolymer, and then polymerizing the prepolymer and a soft segment material to obtain a bio-based polyamide elastomer.

In a specific embodiment of the present disclosure, the molar ratio of the prepolymer to the soft segment material is in a range from 0.7:1 to 2:1, 0.8:1 to 1.5:1, 0.7:1 to 1.3:1, or 0.8:1 to 1.2:1, for example 0.94:1, 0.92:1, 1.12:1, 0.84:1, 1.10:1, 0.87:1, 0.93:1, 1.14:1, 1.48:1, 0.86:1, 1.45:1.

In a specific embodiment of the present disclosure, one or both of pentanediamine and the dicarboxylic acid used as raw materials are obtained by biological methods. For example, pentanediamine is obtained biologically by the action of lysine decarboxylase on lysine.

In some embodiments, the raw materials for preparing the bio-based polyamide elastomer may optionally include an additive selected from a lubricant, a nucleating agent and an antioxidant, etc. The lubricant includes an aliphatic amide, an aliphatic alcohol, an aliphatic bisamide and a polyethylene wax, etc. The nucleating agent includes silica, talc powder, kaolin, and clay, etc. The antioxidant includes hindered phenolic compounds, hydroquinone compounds, hydroquinol compounds, phosphite compounds and substituted derivatives thereof, iodides thereof, and copper salts thereof, etc.

In a specific embodiment of the present disclosure, the additive is present in the bio-based polyamide elastomer at 5 wt. % or less, more preferably 3 wt. % or less, for example 0.1 wt. % to 3 wt. %.

In some embodiments, the bio-based polyamide elastomer has a density of 1.01 to 1.2 g/mL.

In some embodiments, the bio-based polyamide elastomer has a Shore hardness of 25 D to 80 D, for example 33 D, 45 D, 52 D, 63 D, 35 D, 42 D, 67 D, 50 D, and 71 D.

In some embodiments, the bio-based polyamide elastomer has an elongation at break of 200% or more, or, 300% to 1200%, for example 382%, 539%, 680%, 730%, 426%, 566%, and 387%.

In some embodiments, the bio-based polyamide elastomer has a tensile strength of 15-60 MPa, 17-50 MPa, or 20-60 MPa.

In some embodiments, the bio-based polyamide elastomer has an izod notched impact strength of 8 KJ/m² or more, preferably NB (no breaking).

In some embodiments, the bio-based polyamide elastomer has a melting point of 150 to 260° C.

The present disclosure also provides a method for preparing the bio-based polyamide elastomer as described above, comprising:

preparation of a prepolymer: pentanediamine, a dicarboxylic acid, and a first catalyst are mixed with water to prepare an aqueous polyamide salt solution; the aqueous polyamide salt solution is heated to a temperature of 200-250° C., e.g. 220° C.; the pressure is increased to 1.5-3.0 MPa, e.g. 1.7 MPa; water is removed by degassing; when the temperature reaches 240-270° C., e.g. 250° C., a vacuum of −0.01 MPa to −0.1 MPa, e.g. −0.06 MPa is applied and kept for 5-60 minutes, e.g. 20 minutes, to obtain a prepolymer;

polymerization of an elastomer: the prepolymer, a soft segment material and a second catalyst are polymerized to obtain a polyamide elastomer.

In some embodiments, the dicarboxylic acid in the preparation of a prepolymer is at least one selected from the group consisting of 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

In some embodiments, the first catalyst is one or more selected from phosphoric acid, phosphorous acid, trimethyl phosphite, triphenyl phosphite, trimethyl phosphate, triphenyl phosphate, sodium hypophosphite, zinc phosphite, calcium phosphite, and potassium phosphate, preferably sodium hypophosphite.

In some embodiments, the second catalyst is one or more selected from a titanium-based catalyst, a zirconium-based catalyst, an antimony-based catalyst, and a germanium-based catalyst. The titanium-based catalyst is preferably one or more selected from tetrabutyl titanate, tetraethyl titanate, and tetrapropyl titanate. The zirconium-based catalyst is preferably tetrabutyl zirconate and/or tetrapropyl zirconate. The antimony-based catalyst is preferably ethylene glycol antimony. The germanium-based catalyst is preferably GeO₂.

In some embodiments, the second catalyst is one or more selected from phosphoric acid, phosphorous acid, trimethyl phosphite, triphenyl phosphite, trimethyl phosphate, triphenyl phosphate, sodium phosphite, sodium hypophosphite, zinc phosphite, calcium phosphite, and potassium phosphate, preferably sodium hypophosphite.

Preferably, the molar ratio of pentanediamine to the dicarboxylic acid is in a range from 1:1 to 1:2, more preferably from 1:1 to 1:1.5, or 1:1 to 1:1.3.

Preferably, the first catalyst is added in an amount of 0.001 mol % to 5 mol %, preferably 1 mol % to 2 mol %, for example 1.4 mol % or 1.5 mol %, relative to the sum of the pentanediamine, the dicarboxylic acid and the first catalyst.

Preferably, the second catalyst is added in an amount of 0.001 mol % to 3 mol %, preferably 0.01 mol % to 1.4 mol %, for example 1 mol %, or 1.15 mol %, relative to the sum of the prepolymer, the soft segment material and the second catalyst.

Preferably, the aforementioned additive(s) is/are also added to the aqueous polyamide salt solution preferably in an amount of 0.001 mol % to 5 mol % relative to the sum of pentanediamine, the dicarboxylic acid, and the additive(s).

In some embodiments, the method is carried out in a vacuum, nitrogen, or inert gas atmosphere. The inert gas generally refers to one or more of neon gas, argon gas, krypton gas, xenon gas and radon gas.

In some embodiments, the aqueous polyamide salt solution is prepared in a salt forming kettle.

In some embodiments, the aqueous polyamide salt solution is heated in a polymerization kettle.

In some embodiments, the polymerization of an elastomer is carried out in a polyester kettle.

In some embodiments, the molar ratio of the prepolymer to the soft segment material is in a range from 0.7:1 to 2:1, from 0.8:1 to 1.5:1, from 0.7:1 to 1.3:1, or from 0.8:1 to 1.2:1, for example 0.94:1, 0.92:1, 1.12:1, 0.84:1, 1.10:1, 0.87:1, 0.93 : 1, 1.14:1, 1.48:1, 0.86:1, 1.45:1.

In some embodiments, the soft segment material is polytetramethylene ether glycol which has a number-average molecular weight of 500 to 5,000, for example PTMEG 1000 having a molecular weight of 1,000, and PTMEG 2000 having a molecular weight of 2,000.

In some embodiments, the polymerization of an elastomer comprising:

the prepolymer and a soft segment material are mixed at 220-260° C., e.g. 240° C. for 10-120 minutes, e.g. 90 minutes, and then a second catalyst is added to get a mixture;

the mixture is stirred under vacuum conditions of −0.01 MPa to −0.09 MPa, e.g. −0.06 MPa for 1-5 hours, e.g. 2 hours;

the absolute pressure is reduced to 500 Pa or less than 500 Pa within 0.5-2 hours;

the prepolymer and the soft segment material are continued to react for 1-10 hours, preferably 1.5-5 hours, more preferably 1-5 hours, for example 1.5 hours, 2 hours, 2.5 hours and 3.5 hours to obtain a polyamide elastomer.

In some embodiments, the polymerization of an elastomer comprising:

the prepolymer and a soft segment comprising a polyether amine material are mixed at 220-260 ºC for 30-120 minutes and then a second catalyst is added to get a mixture;

the mixture is stirred under vacuum conditions of −0.01 MPa to −0.09 MPa for 1-5 hours;

the relative pressure is reduced to −0.09 to −0.1 MPa within 0.5-3 hours;

the prepolymer and the soft segment material are continued to react for 1-10 hours to obtain a polyamide elastomer.

Preferably, the polymerization of an elastomer also includes introducing nitrogen gas to positive pressure before discharging the polyamide elastomer.

The bio-based polyamide elastomer can be formed into any desired shape by a molding method such as injection molding, blow molding, and film molding, etc.

The bio-based polyamide elastomer according to the present disclosure can be popularized and applied in the field of shoe materials such as skiing shoes, football shoes, and running shoes, etc. Among them, the bio-based polyamide elastomer is used in the shoe outer shell for the skiing shoes, shoe sole for the football shoes and shoe midsole for the running shoes.

On the basis of complying with common knowledge in the art, the above preferred conditions can be arbitrarily combined to obtain the preferred examples of the present disclosure.

The reagents and raw materials used in the present disclosure are commercially available.

The advantageous effect of the present disclosure is that the polyamide elastomer is prepared using pentanediamine and long-chain (C10 to C18) aliphatic dicarboxylic acid which are prepared by biological methods, and a specific proportion of polytetramethylene ether glycol as raw materials, while its properties are comparable to those of the Pebax series elastomers from Arkema Company. The polyamide elastomer has good elasticity, high hardness, and a wide range of application, and at the same time, it has a great price advantage, which is a huge driving force for the industrialization of high-performance polyamide elastomers, especially in the field of footwear applications. The method of preparing the polyamide elastomer of the present disclosure is low cost and the polyamide elastomer is renewable.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present embodiments, suitable methods and materials are described below. The materials, methods, and Examples described herein are illustrative only and not intended to be limiting. The following examples are provided to describe the disclosure in further detail. These examples, which set forth a preferred mode presently contemplated for carrying out the invention, are intended to illustrate and not to limit the disclosure. In the following examples and comparative examples, the melting point was tested with reference to the ISO 11357-3. The Shore D hardness was measured in accordance with ISO 7619. The tensile test (including elongation at break and tensile strength) was conducted in accordance with ISO 527. The izod notched impact strength was measured in accordance with ISO 180. The density was measured in accordance with ISO 1183.

The relative viscosity ηᵣ was determined by using an Ubbelohde viscometer as follows: preparing a sample solution by adding 0.5±0.0002 g of a dried sample to 50 mL of concentrated sulfuric acid (96%) or formic acid (98%) to dissolve the sample, and measuring and recording the flow time (t₀) of the acid (H₂SO₄ or HCOOH) and the flow time (t) of the sample solution in a water bath at a constant-temperature of 25±0.02° C.; determining the relative viscosity by calculation formula:

relative viscosity ηᵣ=t/t₀;

where t refers to the flow time of the sample solution; and t₀ refers to the flow time of the acid as a solvent.

Raw materials in the examples and comparative examples:

pentanediamine, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, and 1,16-hexadecanedioic acid, are purchased from Cathay (Jin Xiang) Biomaterial Co., Ltd., and are produced by biological methods; polytetramethylene ether glycol (PTMEG) is purchased from Changlian Chemical (Changchun).

### Example 1

Under a nitrogen atmosphere, 366.94 mol of pure water and 19.41 mol of pentanediamine were added to a salt forming kettle under stirring, then 19.41 mol of 1,11-undecanedioic acid, 4.35 mol of 1,6-adipic acid, and 0.65 mol of sodium hypophosphite as a catalyst were added to prepare an aqueous polyamide salt solution. Under a nitrogen atmosphere, the aqueous polyamide salt solution was transferred to a polymerization kettle, and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 3.69 mol of carboxyl-terminated prepolymer with a yield of 85% and a number-average molecular weight of 1,406, which was dried for later use.

Under a nitrogen atmosphere, 3.48 mol of carboxyl-terminated prepolymer and 3.69 mol of PTMEG1000 were poured into a reaction kettle and mixed at 240° C. for 90 minutes, 71.7 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced into the kettle to positive pressure. The resulting material was discharged and cut into pellets to give 0.13 mol of polyamide elastomer with a yield of 60% and a number-average molecular weight of 39,596. The structural units contained in the polyamide elastomer and molar ratios thereof are shown in Table 1, and the performance test results of the polyamide elastomer are shown in Table 3.

### Example 2

Under a nitrogen atmosphere, 360.23 mol of pure water and 19.51 mol of pentanediamine were added to a salt forming kettle under stirring, then 22.87 mol of 1,14-tetradecanedioic acid, and 0.63 mol of sodium hypophosphite as a catalyst were added to prepare an aqueous polyamide salt solution. Under a nitrogen atmosphere, the aqueous polyamide salt solution was transferred to a polymerization kettle and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 2.75 mol of carboxyl-terminated prepolymer with a yield of 82% and a number-average molecular weight of 2,140, which was dried for later use.

Under a nitrogen atmosphere, 2.40 mol of carboxyl-terminated prepolymer and 2.62 mol of PTMEG1000 were poured into a reaction kettle and mixed at 240° C. for 90 minutes, 50.2 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced in the kettle to positive pressure. The resulting material was discharged and cut into pellets to give 0.15 mol of polyamide elastomer with a yield of 66% and a number-average molecular weight of 34,507. The structural units contained in the polyamide elastomer and molar ratios thereof are shown in Table 1, and the performance test results of the polyamide elastomer are shown in Table 3.

### Example 3

Under a nitrogen atmosphere, 347.39 mol of pure water and 19.22 mol of pentanediamine were added to a salt forming kettle under stirring, then 21.65 mol of 1,15-pentadecanedioic acid, and 0.61 mol of sodium hypophosphite as a catalyst were added to prepare an aqueous polyamide salt solution. Under a nitrogen atmosphere, the aqueous polyamide salt solution was transferred to a polymerization kettle, and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 2.10 mol of carboxyl-terminated prepolymer with a yield of 86% and a number-average molecular weight of 2935, which was dried for later use.

Under a nitrogen atmosphere, 1.74 mol of carboxyl-terminated prepolymer and 1.55 mol of PTMEG2000 were poured into a reaction kettle and mixed at 240° C. for 90 minutes, 32.9 mmol of catalyst tetrabutyl titanate was added thereto, then the resulting mixture was stirred under vacuum conditions of −0.06 MPa for 2 hours. The absolute pressure inside the kettle was reduced to less than 500 Pa within 2 hours, and then the reaction was continued for 1.5 hours, after which nitrogen gas was introduced into the kettle to positive pressure. The resulting material was discharged and cut into pellets to give 0.14 mol of polyamide elastomer with a yield of 68% and a number-average molecular weight of 35,880. The structural units contained in the polyamide elastomer and molar ratios thereof are shown in Table 1, and the performance test results of the polyamide elastomer are shown in Table 3.

### Example 4

Under a nitrogen atmosphere, 332.01 mol of pure water and 18.82 mol of pentanediamine were added to a salt forming kettle under stirring, then 20.24 mol of 1,16-hexadecanedioic acid, and 0.58 mol of sodium hypophosphite as a catalyst were added to prepare an aqueous polyamide salt solution. Under a nitrogen atmosphere, the aqueous polyamide salt solution was transferred to a polymerization kettle and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 1.19 mol of carboxyl-terminated prepolymer with a yield of 84% and a number-average molecular weight of 4948, which was dried for later use.

Under a nitrogen atmosphere, 1.01 mol of carboxyl-terminated prepolymer and 1.20 mol of PTMEG2000 were poured into a reaction kettle and mixed at 240° C. for 90 minutes, 22.1 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced into the kettle to positive pressure. The resulting material was discharged and cut into pellets to give 0.19 mol of polyamide elastomer with a yield of 65% and a number-average molecular weight of 39,022. The structural units contained in the polyamide elastomer and molar ratios thereof are shown in Table 1, and the performance test results of the polyamide elastomer are shown in Table 3.

### Example 5

Under a nitrogen atmosphere, 341.02 mol of pure water and 18.92 mol of pentanediamine were added to a salt forming kettle under stirring, then 21.20 mol of 1,11-undecanedioic acid, and 0.60 mol of sodium hypophosphite as a catalyst were added to prepare an aqueous polyamide salt solution. Under a nitrogen atmosphere, the aqueous polyamide salt solution was transferred to a polymerization kettle and heated to 220° C., the pressure inside the kettle was increased to 1.7 MPa and water was removed by degassing; when the temperature inside the kettle was increased to 250° C., the kettle was vacuumized to −0.06 MPa and kept for 20 minutes to give 1.99 mol of carboxyl-terminated prepolymer with a yield of 87% and a number-average molecular weight of 2,554, which was dried for later use.

Under a nitrogen atmosphere, 2.03 mol of carboxyl-terminated prepolymer and 1.85 mol of PTMEG1000 were poured into a reaction kettle and mixed at 240° C. for 90 minutes, 15.8 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2.5 hours, after which nitrogen gas was introduced into the kettle to positive pressure. The resulting material was discharged and cut into pellets to give 0.12 mol of polyamide elastomer with a yield of 65% and a number-average molecular weight of 38,160. The structural units contained in the polyamide elastomer and molar ratios thereof are shown in Table 1, and the performance test results of the polyamide elastomer are shown in Table 3.

### Example 6

Under a nitrogen atmosphere, 346.63 mol of pure water and 19.61 mol of pentanediamine were added to a salt forming kettle under stirring, then 21.17 mol of 1,11-undecanedioic acid, and 0.61 mol of sodium hypophosphite as a catalyst were added to prepare an aqueous polyamide salt solution. Under a nitrogen atmosphere, the aqueous polyamide salt solution was transferred to a polymerization kettle and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 1.34 mol of carboxyl-terminated prepolymer with a yield of 86% and a number-average molecular weight of 3,763, which was dried for later use.

Under a nitrogen atmosphere, 1.41 mol of carboxyl-terminated prepolymer and 1.63 mol of PTMEG1000 were poured into a reaction kettle and mixed at 240° C. for 90 minutes, 35.4 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced into the kettle to positive pressure. The resulting material was discharged and cut into pellets to give 0.15 mol of polyamide elastomer with a yield of 69% and a number-average molecular weight of 31,860. The structural units contained in the polyamide elastomer and molar ratios thereof are shown in Table 1, and the performance test results of the polyamide elastomer are shown in Table 3.

### Example 7

Under a nitrogen atmosphere, 339.76 mol of pure water and 19.57 mol of pentanediamine were added to a salt forming kettle under stirring, then 29.36 mol of 1,11-undecanedioic acid, and 0.10 mol of sodium hypophosphite as a catalyst were added to prepare an aqueous polyamide salt solution. Under a nitrogen atmosphere, the aqueous polyamide salt solution was transferred to a polymerization kettle and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 8.35 mol of carboxyl-terminated prepolymer with a yield of 85% and a number-average molecular weight of 852, which was dried for later use.

Under a nitrogen atmosphere, 1.49 mol of carboxyl-terminated prepolymer and 1.61 mol of PTMEG1000 were poured into a reaction kettle and mixed at 24° C. for 90 minutes, 6.21 mmol of catalyst tetrabutyl titanate was added, and the resulting mixture inside the kettle was stirred under vacuum conditions of −0.06 MPa for 2 hours. The absolute pressure was reduced to less than 500 Pa within 1 hour, and then the reaction was continued for 3 hours, after which nitrogen gas was introduced into the kettle to positive pressure. The resulting material was discharged and cut into pellets to give 0.08 mol of polyamide elastomer with a yield of 67.2% and a number-average molecular weight of 22,739. The structural units contained in the polyamide elastomer and molar ratios thereof are shown in Table 1, and the performance test results of the polyamide elastomer are shown in Table 3.

### Example 8

Under a nitrogen atmosphere, 431.78 mol of pure water and 15.66 mol of pentanediamine were added to a salt forming kettle under stirring, then 19.48 mol of 1,14-tetradecanedioic acid, and 0.07 mol of sodium hypophosphite as a catalyst were added to prepare an aqueous polyamide salt solution. Under a nitrogen atmosphere, the aqueous polyamide salt solution was transferred to a polymerization kettle and heated to 220° C., and the pressure inside the kettle was increased to 1.7 MPa, and water was removed by degassing; when the temperature inside the kettle was increased to 250° C., the kettle was vacuumized to −0.06 MPa and kept for 20 minutes to give 3.30 mol of carboxyl-terminated prepolymer with a yield of 86% and a number-average molecular weight of 1,494, which was dried for later use.

Under a nitrogen atmosphere, 1.13 mol of carboxyl-terminated prepolymer and 0.99 mol of PTMEG1000 were poured into a reaction kettle and mixed at 240° C. for 90 minutes, 8.5 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2.5 hours, after which nitrogen gas was introduced into the kettle to positive pressure; The resulting material was discharged and cut into pellets to give 0.10 mol of polyamide elastomer with a yield of 72% and a number-average molecular weight of 19,659. The structural units contained in the polyamide elastomer and molar ratios thereof are shown in Table 1, and the performance test results of the polyamide elastomer are shown in Table 3.

### Example 9

Under a nitrogen atmosphere, 328.06 mol of pure water and 17.62 mol of pentanediamine were added to a salt forming kettle under stirring, then 18.92 mol of 1,16-hexadecanedioic acid, and 0.24 mol of sodium hypophosphite as a catalyst were added to prepare an aqueous polyamide salt solution. Under a nitrogen atmosphere, the aqueous polyamide salt solution was transferred to a polymerization kettle and heated to 220° C., and the pressure inside the kettle was increased to 1.7 MPa, and water was removed by degassing; when the temperature inside the kettle was increased to 250° C., the kettle was vacuumized to −0.06 MPa and kept for 20 minutes to give 1.07 mol of carboxyl-terminated prepolymer with a yield of 82% and a number-average molecular weight of 4,973, which was dried for later use.

Under a nitrogen atmosphere, 0.46 mol of carboxyl-terminated prepolymer and 0.31 mol of PTMEG2000 were poured into a reaction kettle and mixed at 240° C. for 90 minutes, 1.54 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 3 hours, after which nitrogen gas was introduced into the kettle to positive pressure. The resulting material was discharged and cut into pellets to give 0.12 mol of polyamide elastomer with a yield of 78% and a number-average molecular weight of 18,749. The structural units in the polyamide elastomer and molar ratios thereof are shown in Table 2, and the performance test results of the polyamide elastomer are shown in Table 3.

### Example 10

Under a nitrogen atmosphere, 258.7 mol of pure water and 17.62 mol of pentanediamine were added to a salt forming kettle under stirring, then 19.23 mol of 1,10-decanedioic acid, and 0.061 mol of sodium hypophosphite as a catalyst were added to prepare an aqueous polyamide salt solution. Under a nitrogen atmosphere, the aqueous polyamide salt solution was transferred to a polymerization kettle and heated to 220° C., and the pressure inside the kettle was increased to 1.7 MPa, and water was removed by degassing; when the temperature inside the kettle was increased to 250° C., the kettle was vacuumized to −0.06 MPa and kept for 20 minutes to give 1.35 mol of carboxyl-terminated prepolymer with a yield of 83% and a number-average molecular weight of 3,162, which was dried for later use.

Under a nitrogen atmosphere, 0.81 mol of carboxyl-terminated prepolymer and 0.94 mol of PTMEG2000 were poured into a reaction kettle and mixed at 240° C. for 90 minutes, 5.25 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 3 hours, after which nitrogen gas was introduced into the kettle to positive pressure. The resulting material was discharged and cut into pellets to give 0.09 mol of polyamide elastomer with a yield of 70% and a number-average molecular weight of 33,711. The structural units contained in the polyamide elastomer and molar ratios thereof are shown in

Table 2, and the performance test results of the polyamide elastomer are shown in Table 3.

### Comparative Example 1

Under a nitrogen atmosphere, 588.2 mol of pure water and 33.82 mol of pentanediamine were added to a salt forming kettle under stirring, then 35.38 mol of 1,6-adipic acid, and 0.69 mol of sodium hypophosphite as a catalyst were added to prepare an aqueous polyamide salt solution. Under a nitrogen atmosphere, the aqueous polyamide salt solution was transferred to a polymerization kettle and heated to 220° C., and the pressure inside the kettle was increased to 1.7 MPa, and water was removed by degassing; when the temperature inside the kettle was increased to 250° C., the kettle was vacuumized to −0.06 MPa and kept for 20 minutes to give 1.34 mol of carboxyl-terminated prepolymer with a yield of 86% and a number-average molecular weight of 4,762, which was dried for later use.

Under a nitrogen atmosphere, 1.29 mol of carboxyl-terminated prepolymer and 1.48 mol of PTMEG1000 were poured into a reaction kettle and mixed at 240° C. for 90 minutes, 41.6 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced into the kettle to positive pressure. The resulting material was discharged and cut into pellets to obtain 0.13 mol of polyamide elastomer with a yield of 69% and a number-average molecular weight of 39,170. Structural units contained in the polyamide elastomer and molar ratios thereof are shown in Table 2, and the performance test results of the polyamide elastomer are shown in Table 3.

### Comparative Example 2

Under a nitrogen atmosphere, 393.12 mol of pure water and 22.97 mol of pentanediamine were added to a salt forming kettle under stirring, then 23.28 mol of 1,14-undecanedioic acid, and 0.46 mol of sodium hypophosphite as a catalyst were added to prepare a polyamide salt solution. Under a nitrogen atmosphere, the aqueous polyamide salt solution was transferred to a polymerization kettle and heated to 220° C., and the pressure inside the kettle was increased to 1.7 MPa, and water was removed by degassing when the temperature inside the kettle was increased to 250° C., the kettle was vacuumized to −0.06 MPa and kept for 20 minutes to give 0.27 mol of carboxyl-terminated prepolymer with a yield of 86% and a number-average molecular weight of 20,989, which was dried for later use.

Under a nitrogen atmosphere, 0.25 mol of carboxyl-terminated prepolymer, 1.16 mol of PTMEG 1000 and 0.48 mol of 1,6-adipic acid were poured into a reaction kettle and mixed at 240° C. for 90 minutes, 21.1 mmol of catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 2 hours, after which nitrogen gas was introduced into the kettle to positive pressure. the resulting material was discharged and cut into pellets to give 0.29 mol of polyamide elastomer with a yield of 68% and a number-average molecular weight of 15,112. The structural units contained in the polyamide elastomer and molar ratios thereof are shown in Table 2, and the performance test results of the polyamide elastomer are shown in Table 3.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| | Structural unit (mol %) | (x = 9) | (x = 12) | (x = 13) | (x = 14) | (x = 9) | (x = 9) | (x = 9) | (x = 12) |
| A | 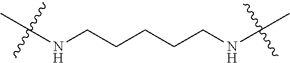 [SMILES: *NCCCCCN*] | 18 | 21 | 19 | 22 | 28 | 30 | 10 | 19 |
| B | 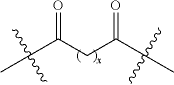 | 18 | 25 | 22 | 24 | 31 | 32 | 15 | 24 |
| E | 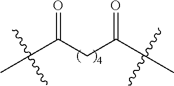 | 4 | 0 | 0 | 0 | 0 | 0 | 0 | 0 |
| D | 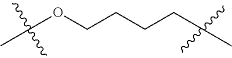 [SMILES: *CCCCO*] | 60 | 54 | 59 | 54 | 41 | 38 | 75 | 57 |

TABLE 2

| | | Ex. 9 | Ex. 10 | CEx. 1 | CEx. 2 |
|---|---|---|---|---|---|
| | Structural unit (mol %) | (x = 14) | (x = 8) | (x = 0) | (x = 9) |
| A | 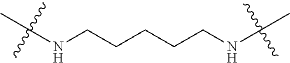 [SMILES: *NCCCCCN*] | 29 | 20 | 36 | 35 |
| B | 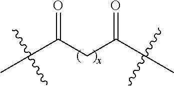 | 31 | 22 | 0 | 35 |
| E | 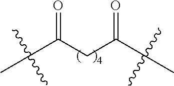 | 0 | 0 | 38 | 0 |
| D | 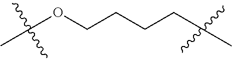 [SMILES: *CCCCO*] | 40 | 58 | 26 | 30 |

TABLE 3

| | | | | | | Izod | |
|---|---|---|---|---|---|---|---|
| | | Relative | | | | notched | |
| | | viscosity (96% | | Elongation | Tensile | impact | Melting |
| | Density | concentrated | Shore | at break | strength | strength | point |
| | (g/mL) | sulfuric acid) | hardness | (%) | (MPa) | (kJ/m²) | (° C.) |
| Ex. 1 | 1.05 | 1.38 | 33D | 730 | 28 | NB | 181 |
| Ex. 2 | 1.05 | 1.42 | 40D | 680 | 32 | NB | 183 |
| Ex. 3 | 1.06 | 1.47 | 52D | 539 | 35 | NB | 183 |
| Ex. 4 | 1.06 | 1.58 | 63D | 382 | 42 | NB | 186 |
| Ex. 5 | 1.05 | 1.46 | 45D | 576 | 36 | NB | 207 |
| Ex. 6 | 1.06 | 1.54 | 55D | 481 | 39 | NB | 209 |
| Ex. 7 | 1.01 | 1.13 | 35D | 609 | 17 | NB | 191 |
| Ex. 8 | 1.02 | 1.19 | 42D | 589 | 19 | NB | 183 |
| Ex. 9 | 1.04 | 1.39 | 67D | 426 | 45 | 18 | 189 |
| Ex. 10 | 1.06 | 1.27 | 50D | 566 | 39 | NB | 211 |
| CEx. 1 | 1.10 | 2.1 | 78D | 105 | 59 | 11 | 254 |
| CEx. 2 | 1.08 | 1.9 | 83D | 67 | 62 | 9 | 213 |

As can be seen from the above examples (Ex) and comparative examples (CEx), the polyamide elastomer in examples 1 to 11 of the present disclosure prepared using pentanediamine and long-chain (C10 to C18) dicarboxylic acid which are prepared by biological methods and a specific proportion of polytetramethylene ether glycol as raw materials, has excellent performance and a stable supply of polymerization monomer, solves the problem of the excessively high cost of polyamide elastomer, expands the application scenarios of elastomers and has very high commercial value. In contrast, in comparative example 1, only 1,6-adipic was used without using long-chain (C10 to C18) dicarboxylic diacid, resulting in high viscosity and low elongation at break of the polyamide elastomer.

### Examples 11-15

Under a nitrogen atmosphere, pure water and pentanediamine were added to a salt forming kettle under stirring, then dicarboxylic acid and first catalyst sodium hypophosphite are mixed with water to prepare an aqueous polyamide salt solution. Under a nitrogen atmosphere, the aqueous polyamide salt solution was transferred to a polymerization kettle, and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give a prepolymer, which was dried for later use. The raw materials and the obtained prepolymer are shown in Table 4a.

Under a nitrogen atmosphere, the obtained prepolymer and the soft segment material were poured into a polyester kettle and mixed at 240° C. for 90 minutes, the second catalyst tetrabutyl titanate was added thereto, then the resulting mixture was stirred under vacuum conditions of −0.06 MPa for 2 hours. The absolute pressure inside the kettle was reduced to less than 500 Pa within 1 hour, and then the reaction was continued for 1 hour, after which nitrogen gas was introduced into the kettle to positive pressure. The resulting material was discharged and cut into pellets to give a polyamide elastomer. The raw materials and the obtained polyamide elastomer are shown in Table 4b, and the performance test results of the polyamide elastomer are shown in Table 5.

### Examples 16

Under a nitrogen atmosphere, 361.94 mol of pure water and 19.57 mol of pentanediamine were added to a salt forming kettle under stirring, then 11.65 mol of 1,10-decanedioic acid, 7.77 mol of 1,13-tridecanedioic acid, 6.47 mol of 1,16-hexadecanedioic acid and 0.04 mol of the first catalyst sodium hypophosphite are mixed with water to prepare an aqueous polyamide salt solution. Under a nitrogen atmosphere, the aqueous polyamide salt solution was transferred to a polymerization kettle, and heated to 220° C., the pressure inside the kettle was increased to 1.7 MPa, and water was removed by degassing; when the temperature inside the kettle was increased to 250° C., the kettle was vacuumized to −0.06 MPa and kept for 20 minutes to give 5.2 mol of prepolymer with a number-average molecular weight of 1004, which was dried for later use.

Under a nitrogen atmosphere, 1.45 mol of the obtained prepolymer and 1.35 mol of Jeffamine® RE-900 (polyether amine) with a number-average molecular weight of 900 were poured into a polyester kettle and mixed at 240° C. for 90 minutes, 0.53 mmol of second catalyst sodium hypophosphite was added thereto, then the resulting mixture was stirred under vacuum conditions of −0.06 MPa for 2 hours. The absolute pressure inside the kettle was reduced to less than −0.09MPa within 1 hour, and then the reaction was continued for 1 hours, after which nitrogen gas was introduced into the kettle to positive pressure. The resulting material was discharged and cut into pellets to give 0.08 mol of polyamide elastomer with a number-average molecular weight of 25,523. The performance test results of the polyamide elastomer are shown in Table 5.

TABLE 4a

| | Ex. 11 | Ex. 12 | Ex. 13 | Ex. 14 | Ex. 15 |
|---|---|---|---|---|---|
| Pure water (mol) | 321.45 | 368.77 | 360 | 369.02 | 367.97 |
| Pentanediamine (mol) | 19.57 | 20.55 | 20.06 | 19.57 | 13.7 |
| 1,10-decanedioic | — | — | 10.19 | — | — |
| acid (mol) | | | | | |
| 1,11-undecanedioic | — | 5.22 | | 8.5 | — |
| acid (mol) | | | | | |
| 1,12-dodecanedioic | — | — | 10.19 | | — |
| acid (mol) | | | | | |
| 1,13-tridecanedioic | 8.81 | 11.75 | — | 8.77 | — |
| acid (mol) | | | | | |
| 1,14-tetradecanedioic | — | — | — | — | 27.4 |
| acid (mol) | | | | | |
| 1,15-pentadecanedioic | 13.21 | 9.14 | — | — | — |
| acid (mol) | | | | | |
| 1,16-hexadecanedioic | — | — | 5.1 | 9.3 | — |
| acid (mol) | | | | | |
| Sodium hypophosphite | 0.08 | 0.05 | 0.04 | 0.04 | 0.09 |
| (mol) | | | | | |
| Prepolymer (mol) | 2 | 4.7 | 4.5 | 6.1 | 12.2 |
| Number-average | 2420 | 1172 | 1026 | 906 | 504 |
| molecular weight | | | | | |
| of Prepolymer | | | | | |

TABLE 4b

| | Ex. 11 | Ex. 12 | Ex. 13 | Ex. 14 | Ex. 15 |
|---|---|---|---|---|---|
| Prepolymer (mol) | 0.86 | 1.39 | 1.36 | 1.61 | 3.15 |
| PTMEG1000 (mol) | 0.77 | 0.92 | 1.46 | 1.43 | 3.33 |
| PTMEG2000 (mol) | — | 0.23 | — | — | — |
| Glycerol (mol) | — | — | — | 0.36 | — |
| Tetrabutyl titanate (mmol) | 3.2 | 5.7 | 5.6 | 5.6 | 5.6 |
| Polyamide elastomer (mol) | 0.06 | 0.07 | 0.07 | 0.12 | 0.15 |
| Number-average molecular | 30470 | 31525 | 27546 | 21581 | 28330 |
| weight of Polyamide elastomer | | | | | |

TABLE 5

| | Ex. 11 | Ex. 12 | Ex. 13 | Ex. 14 | Ex. 15 | Ex. 16 |
|---|---|---|---|---|---|---|
| Density (g/mL) | 1.05 | 1.03 | 1.03 | 1.03 | 1.02 | 1.09 |
| Relative viscosity | 2.92 | 2.65 | 2.73 | 2.81 | 2.41 | 2.53 |
| (98% formic acid) | | | | | | |
| Shore hardness | 56D | 39D | 42D | 41D | 30D | 50D |
| Elongation at break (%) | 583 | 790 | 651 | 624 | 810 | 589 |
| Tensile strength (MPa) | 41 | 39 | 40 | 39 | 36 | 43 |
| Izod notched impact strength (kJ/m2) | NB | NB | NB | NB | NB | NB |
| Melting point (° C.) | 175 | 173 | 163 | 154 | 168 | 165 |

It will be understood that any one or more feature or component of one embodiment described herein can be combined with one or more other features or components of another embodiment. Thus, the present subject matter includes any and all combinations of components or features of the embodiments described herein.

As described herein above, the present subject matter solves many problems. However, it will be appreciated that various changes in the details, materials and arrangements of components and operations, which have been herein described and illustrated in order to explain the nature of the subject matter, may be made by those skilled in the art without departing from the principle and scope of the subject matter, as expressed in the appended claims.

What is claimed is:

1. A bio-based polyamide elastomer comprising a hard segment and a soft segment;
wherein the hard segment comprises a structural unit represented by formula A and a structural unit represented by formula B, which are connected by an amide bond; 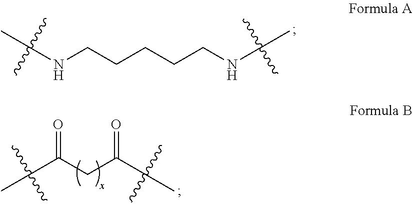
wherein, x is an integer ranging from 4 to 16;
the soft segment is derived from one or more selected from the group consisting of a polyether, a polyol and a polyether amine.

2. The bio-based polyamide elastomer according to claim 1, wherein the structural unit represented by formula A is derived from pentanediamine; and
the structural unit represented by formula B is derived from a dicarboxylic acid; and
the dicarboxylic acid is at least one selected from the group consisting of 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

3. The bio-based polyamide elastomer according to claim 1, wherein the molar ratio of pentanediamine to the dicarboxylic acid is in a range from 1:1.0 to 1:2.0.

4. The bio-based polyamide elastomer according to claim 1, wherein the molar ratio of the hard segment to the soft segment is in a range from 0.7:1 to 2:1.

5. The bio-based polyamide elastomer according to claim 1, wherein the bio-based polyamide elastomer has a relative viscosity of 1.0 to 2.0, which is measured by using a mobile phase of 96% concentrated sulfuric acid, and/or
the bio-based polyamide elastomer has a relative viscosity of 2.2 to 3.5, which is measured by using a mobile phase of 98% formic acid.

6. The bio-based polyamide elastomer according to claim 1, wherein the hard segment has a number-average molecular weight of 500 to 12,000,
the soft segment has a number-average molecular weight of 200 to 5,000, and/or
the bio-based polyamide elastomer has a number-average molecular weight ranging 10,000 to 70,000.

7. The bio-based polyamide elastomer according to claim 1, wherein the polyether is one or more selected from the group consisting of a polyether diol and a polyether polyol;
the polyether diol is one or more selected from the group consisting of polyethylene glycol (PEG), polypropylene glycol (PPG), polybutylene glycol (PTMG) and polytetramethylene ether glycol (PTMEG); and/or
the polyether polyol is one or more selected from the group consisting of polypropyltriol, polybutyltetrol and polytetrahydrofuran ether triol.

8. The bio-based polyamide elastomer according to claim 7, wherein the polytetramethylene ether glycol has a number-average molecular weight of 500 to 5,000, or 500 to 2,000.

9. The bio-based polyamide elastomer according to claim 1, wherein the polyol is one or more selected from the group consisting of pentaerythritol, ethylene glycol (EG), 1,2-propanediol (PG), glycerol, 1,4-butanediol (BDO), 1,6-hexanediol (HD), neopentyl glycol (NPG), diethylene glycol, dipropylene glycol, trimethylolpropane (TMP).

10. The bio-based polyamide elastomer according to claim 1, wherein the polyether amine is one or more selected from the group consisting of polyethylene glycol ether amine, polypropylene glycol ether amine, and polybutylene glycol ether amine.

11. The bio-based polyamide elastomer according to claim 2, wherein
the dicarboxylic acid is one or more selected from the group consisting of 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid; and
the soft segment is derived from one or more selected from a group consisting of a polytetramethylene ether glycol, a polytetramethylene ether glycol and a polyol, and a polyether amine.

12. The bio-based polyamide elastomer according to claim 1, wherein
the bio-based polyamide elastomer has a density of 1.01 to 1.2 g/mL; and/or
the bio-based polyamide elastomer has Shore hardness ranges from 25 D to 80 D; and/or
the bio-based polyamide elastomer has an elongation at break of 200% or more; and/or
the bio-based polyamide elastomer has a tensile strength of 15 MPa to 60 MPa; and/or
the bio-based polyamide elastomer has an Izod notched impact strength of 8 KJ/m² or more; and/or
the bio-based polyamide elastomer has a melting point of 150 to 260° C.

13. The bio-based polyamide elastomer according to claim 1, wherein the bio-based polyamide elastomer is prepared by a method comprising: polymerizing pentanediamine and a dicarboxylic acid to obtain a prepolymer, and then polymerizing the prepolymer and a soft segment material to obtain a bio-based polyamide elastomer.

14. The bio-based polyamide elastomer according to claim 13, one or both of pentanediamine and the dicarboxylic diacid used as raw materials are obtained by biological methods.

15. A method for preparing the bio-based polyamide elastomer according to claim 1, comprising:
preparation of a prepolymer: pentanediamine, a dicarboxylic acid and a first catalyst are mixed with water to prepare an aqueous polyamide salt solution; the aqueous polyamide salt solution is heated to a temperature of 200 to 250° C., the pressure is increased to 1.5 to 3.0 MPa and water is removed by degassing; when the temperature reaches 240 to 270° C., a vacuum of −0.01 MPa to −0.1 MPa is applied and kept for 5 to 60 minutes to obtain a carboxyl-terminated prepolymer;
polymerization of an elastomer: the prepolymer, a soft segment material and a second catalyst are polymerized to obtain a polyamide elastomer;
wherein the dicarboxylic acid in the preparation of a prepolymer is at least one selected from the group consisting of 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

16. The method for preparing the bio-based polyamide elastomer according to claim 15, wherein
the first catalyst is one or more selected from phosphoric acid, phosphorous acid, trimethyl phosphite, triphenyl phosphite, trimethyl phosphate, triphenyl phosphate, sodium hypophosphate, zinc phosphite, calcium phosphite and potassium phosphate; and
the second catalyst is one or more selected from a titanium-based catalyst, a zirconium-based catalyst, an antimony-based catalyst and a germanium-based catalyst.

17. The method for preparing the bio-based polyamide elastomer according to claim 15, wherein the molar ratio of the prepolymer to the soft segment material is in a range from 0.7:1 to 2:1.

18. The method for preparing the bio-based polyamide elastomer according to claim 15, wherein the first catalyst is added in an amount of 0.001 mol % to 5 mol %; and/or
the second catalyst is added in an amount of 0.001 mol % to 3 mol %.

19. The method for preparing the bio-based polyamide elastomer according to claim 15, wherein the polymerization comprising:
the prepolymer and the soft segment material are mixed at 220-260° C. for 10-120 minutes, and then the second catalyst is added to get a mixture;
the mixture was stirred under vacuum conditions of −0.01 MPa to −0.09 MPa;
the absolute pressure is reduced to 500 Pa or less than 500 Pa within 0.5-2 hours, or the relative pressure is reduced to −0.09 to −0.1 Mpa within 0.5-3 hours;
the prepolymer and the soft segment material are continued to react for 1-10 hours to obtain a polyamide elastomer.

20. The method for preparing the bio-based polyamide elastomer according to claim 15, wherein
the titanium-based catalyst is one or more selected from the group consisting of tetrabutyl titanate, tetraethyl titanate, and tetrapropyl titanate;
the zirconium-based catalyst is one or more selected from the group consisting of tetrabutyl zirconate and tetrapropyl zirconate;
the antimony-based catalyst is ethylene glycol antimony; and/or
the germanium-based catalyst is GeO₂.
